(19) United States
(12) Patent Application Publication
(10) Pub. No.: US 2013/0195170 A1
(43) Pub. Date: Aug. 1, 2013

(54) DATA TRANSMISSION APPARATUS, DATA TRANSMISSION METHOD, AND STORAGE MEDIUM

(71) Applicant: CANON KABUSHIKI KAISHA, Tokyo (JP)

(72) Inventor: Katsutoshi Tajiri, Inagi-shi (JP)

(73) Assignee: CANON KABUSHIKI KAISHA, Tokyo (JP)

(21) Appl. No.: 13/748,784

(22) Filed: Jan. 24, 2013

(30) Foreign Application Priority Data
Jan. 26, 2012 (JP) 2012-014585

(51) Int. Cl. H04N 7/26

(52) U.S. Cl. CPC H04N 19/00133
USPC 375/240.02

(57) ABSTRACT

A data transmission apparatus includes: a coding unit configured to code moving image data for each frame of the moving image data using an intra-frame coding method and an inter-frame coding method; an acquisition unit configured to acquire a set time that sets an upper limit of a time from a start of coding processing of a first frame using the intra-frame coding method to a start of coding processing of a second frame using the intra-frame coding method; and a decision unit configured to decide, based on at least a length of the set time, whether to code, using the intra-frame coding method, a third frame that undergoes coding processing during a time from the start of the coding processing of the first frame to an elapse of the set time.

### BACKGROUND OF THE INVENTION

1. Field of the Invention

The present invention relates to a data transmission apparatus, a data transmission method, and a storage medium and, more particularly, to a moving image data video processing technique using inter-frame predictive coding.

2. Description of the Related Art

Video distribution systems using an IP (Internet Protocol) network such as the Internet are recently growing in number. A video distribution system is employed in an Internet site for distributing, for example, the situation of a ski slope or a zoo. Monitoring a store/building or the like is also done by adopting a video distribution system using a network.

Such a video distribution system often distributes/accumulates a high-quality video with a small data amount using inter-frame predictive coding such as H.264. The inter-frame predictive coding uses intra-frame-coded frames (I frames) having video information necessary for constructing a complete video frame and inter-frame-coded frames (P and B frames) having video information of the difference from a predicted image. The following explanation will be made while defining the intra-frame-coded frame as an independent frame and the inter-frame-coded frame as a dependent frame.

In general, a dependent frame needs an independent frame serving as a base. Video data includes a plurality of dependent frames for one independent frame. The group of the independent frame and the dependent frames is called a GOP (Group Of Picture). The independent frame generally includes complete video information and therefore has a data amount larger than that of a dependent frame. To place importance on the image quality, the ratio of independent frames is increased. To place importance on the video data compression efficiency, the ratio of dependent frames is increased. Conventionally, when dependent frames such as P frames continue, an immediately preceding dependent frame is also necessary. If a certain dependent frame corresponding to a given independent frame cannot be generated due to some reason, reproduction cannot be done until the next independent frame is generated.

Japanese Patent Laid-Open No. 2006-508574 discloses a technique of causing a data reception apparatus to request a data transmission apparatus to insert an independent frame upon detecting a packet loss.

Japanese Patent Laid-Open No. 2008-131143 also discloses a technique of causing a data reception apparatus to request a data transmission apparatus to transmit an independent frame in case of a frame loss in a GOP.

In the conventional techniques disclosed in Japanese Patent Laid-Open No. 2006-508574 and Japanese Patent Laid-Open No. 2008-131143, however, the independent frame cannot be inserted without the independent frame insertion request from the reception apparatus. Additionally, if independent frame requests continuously occur, the independent frames including a large quantity of data are continuously generated. This leads to an increase in the load on transmission processing or the network.

### SUMMARY OF THE INVENTION

The present invention provides a video processing technique of reducing the video reproduction disable time by inserting an independent frame without waiting for an independent frame insertion request from a reception apparatus even in a state in which not all video frames can be generated due to a high processing load.

The present invention also provides a video processing technique capable of reducing the load on transmission processing or a network by prohibiting continuous generation of independent frames even in a state in which video frame loss continuously occur.

According to one aspect of the present invention, there is provided a data transmission apparatus for transmitting coded moving image data to a reception apparatus via a network, comprising: a coding unit configured to code the moving image data for each frame of the moving image data using an intra-frame coding method that needs no information of other frames upon decoding and an inter-frame coding method that needs the information of other frames upon decoding; an acquisition unit configured to acquire a set time that sets an upper limit of a time from a start of coding processing of a first frame using the intra-frame coding method by the coding unit to a start of coding processing of a second frame using the intra-frame coding method by the coding unit; and a decision unit configured to decide, based on at least a length of the set time, whether to code, using the intra-frame coding method, a third frame that undergoes coding processing during a time from the start of the coding processing of the first frame to an elapse of the set time.

Further features of the present invention will become apparent from the following description of exemplary embodiments (with reference to the attached drawings).

### BRIEF DESCRIPTION OF THE DRAWINGS

FIG. 1 is a block diagram showing the software configuration of a camera server;

FIG. 2 is a block diagram showing the arrangement of a video processing system according to an embodiment;

FIG. 3 is a block diagram showing the hardware arrangement of the camera server;

FIGS. 4A and 4B are views exemplifying video frames that have suffered frame loss;

FIG. 5 is a flowchart showing the procedure of processing of a video processing apparatus according to the first embodiment;

FIG. 6 is a flowchart showing the procedure of processing of a video processing apparatus according to the second embodiment;

FIG. 7 is a flowchart showing the procedure of processing of a video processing apparatus according to the third embodiment; and

FIGS. 8A and 8B are flowcharts showing the procedure of processing of a video processing apparatus according to the fourth embodiment.

### DESCRIPTION OF THE EMBODIMENTS

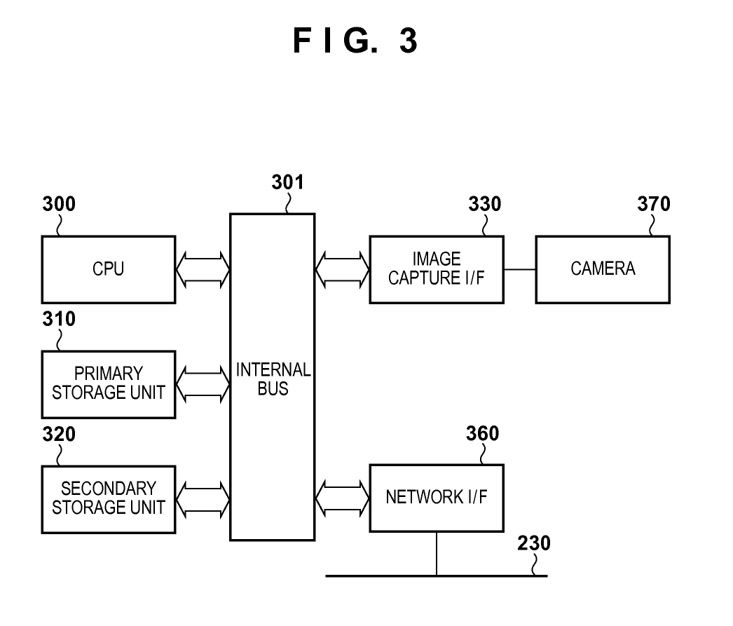

An embodiment of the present invention will be described in detail with reference to the accompanying drawings. FIG. 2 is a block diagram showing the arrangement of a video processing system according to the embodiment of the present invention. A camera server 200 and a client 220 are connected to each other via a network 230. The camera server 200 includes an image capture apparatus (camera). The angle of view of the camera for image capture can be varied or fixed. The camera server 200 can distribute, via the network 230, image data captured by the camera. The client 220 can access the camera server 200 and acquire the image data. Details of the camera server 200 will be described later.

Note that for the sake of simplicity, the video processing system is assumed to include only one camera server. However, the video processing system may include a plurality of camera servers.

There may exist any client other than the client 220, which accesses the camera server 200 and receives or accumulates image data.

The network 230 is formed from a plurality of routers, switches, cables, and the like, which satisfy the communication standard such as Ethernet®. In the embodiment of the present invention, the communication standard, scale, and arrangement are not particularly limited if communication between the server and the client can be done without any trouble. The network 230 is applicable to, for example, the Internet to a LAN (Local Area Network).

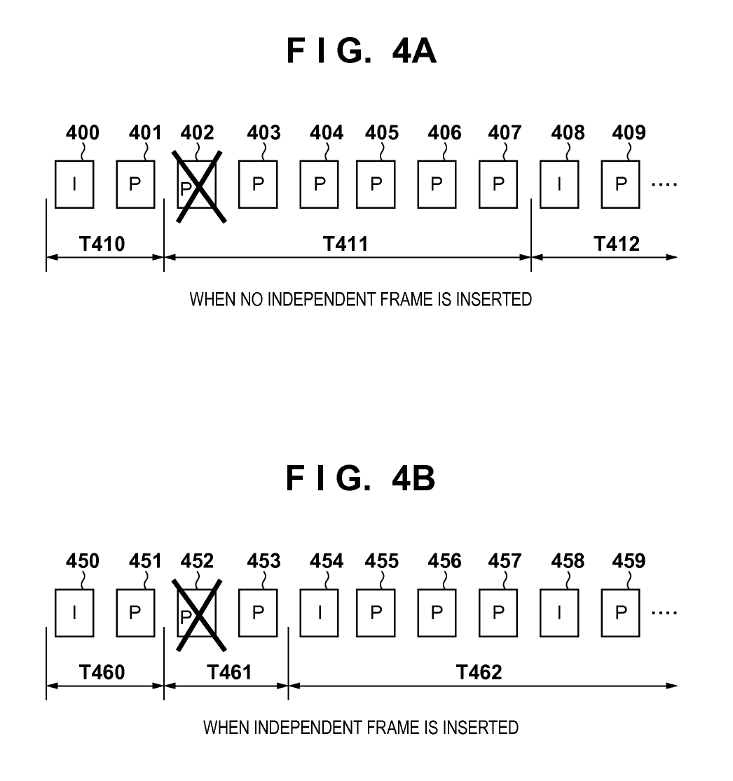

FIG. 3 is a block diagram showing the hardware arrangement of the camera server 200. A CPU (Central Processing Unit) 300, a primary storage unit 310, a secondary storage unit 320, an image capture interface (I/F) 330, and a network interface (I/F) 360 are connected to each other via an internal bus 301.

The CPU 300 reads out a program stored in the secondary storage unit 320 and executes it to control the operation of each component of the camera server 200.

The primary storage unit 310 is a writable high-speed storage unit represented by, for example, a RAM. The OS, various kinds of programs, and various kinds of data are loaded to the primary storage unit 310. The primary storage unit 310 also serves as the work area of the OS and various kinds of programs. The secondary storage unit 320 is a nonvolatile storage unit represented by, for example, an FDD, an HDD, a flash memory, a CD-ROM drive, and the like. The secondary storage unit 320 is used as a permanent storage area of the OS, various kinds of programs, and various kinds of data and also as a short-term storage area of various kinds of data. Details of the various kinds of programs and the like stored in the primary storage unit 310 and the secondary storage unit 320 of the camera server 200 will be described later.

A camera 370 is connected to the image capture interface 330. The image capture interface 330 converts/compresses video data (image data) captured by the camera 370 into a predetermined format and transfers it to the primary storage unit 310. The network interface 360 is an interface to connect the network 230 and communicates with the client 220 or the like via a communication medium such as Ethernet.

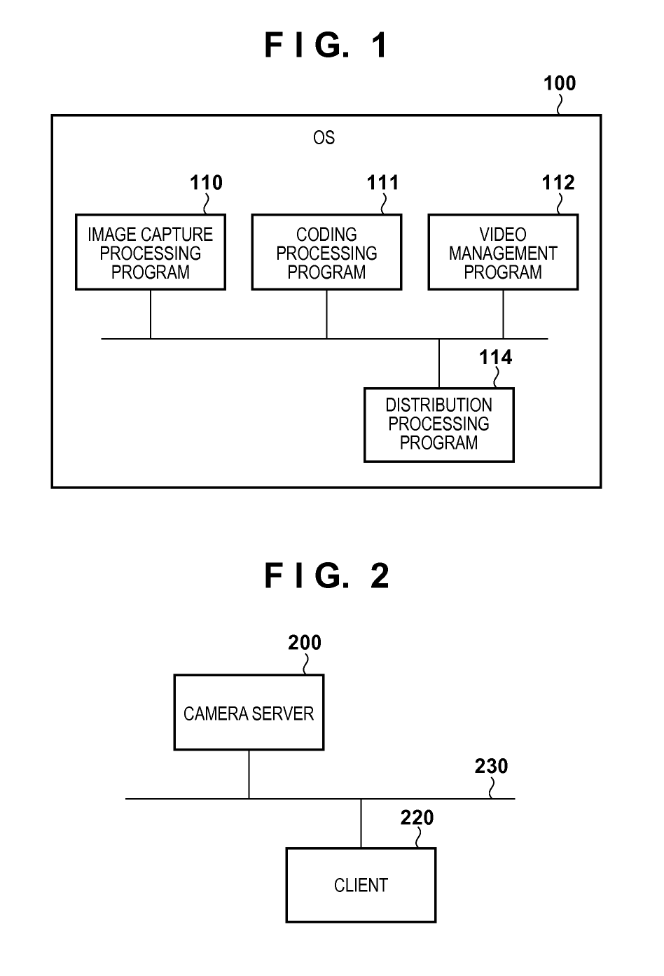

FIG. 1 is a block diagram showing the software configuration of the camera server 200. An OS 100, an image capture processing program 110, a coding processing program 111, a video management program 112, and a distribution processing program 114 are loaded onto the primary storage unit 310. Each program is executed under the hardware arrangement shown in FIG. 3, thereby constituting the camera server 200 having processing functions corresponding to the processes of the respective programs.

The OS 100 is the basic program that controls the entire camera server 200. The image capture processing program 110 acquires, via the image capture interface 330, video data captured by the camera 370, and transmits it to the coding processing program 111. The coding processing program 111 receives the video data transmitted from the image capture processing program 110. The coding processing program 111 then generates a video frame (independent frame or dependent frame) in accordance with an inter-frame predictive coding setting designated in advance. The inter-frame predictive coding setting sets the upper limit of the time from the start of coding processing of a first frame using the intra-frame coding method to the start of coding processing of a second frame using the intra-frame coding method by the coding processing program 111.

The coding processing program 111 generates a video frame by performing intra-frame coding processing of the video data once a predetermined time corresponding to the inter-frame predictive coding setting. The coding processing program 111 also generates a video frame by performing inter-frame coding processing of the video data a plurality of times within a predetermined time corresponding to the inter-frame predictive coding setting.

However, the coding processing program 111 can perform intra-frame coding processing of the second frame during the period until a time corresponding to the inter-frame predictive coding setting elapses from the start of intra-frame coding processing of the first frame. When the intra-frame coding processing of the second frame is performed in this way, the coding processing program 111 performs the intra-frame coding processing of the video data once a time corresponding to the inter-frame predictive coding setting after the start of the intra-frame coding processing of the second frame. Alternatively, when the intra-frame coding processing of the second frame is performed in the above-described way, the intra-frame coding processing of the video data may be performed once a time corresponding to the inter-frame predictive coding setting after the start of the intra-frame coding processing of the first frame.

The coding processing program 111 generates independent frames (I frames) having video information necessary for constructing a complete video frame by intra-frame coding, and generates dependent frames (P and B frames) having video information of the difference from a predicted image by inter-frame coding. If a request from the video management program 112 is received, the coding processing program 111 generates an independent frame. The generated video frame is saved in the primary storage unit 310. The video management program 112 confirms whether the video frames generated by the coding processing program 111 continue, and if they continue, requests the distribution processing program 114 to do video frame transmission processing. If the video frames do not continue, the video management program 112 requests the coding processing program 111 to generate an independent frame. The distribution processing program 114 distributes the video frames saved in the primary storage unit 310 in a predetermined format in response to a request (image acquisition request) from the client 220. At this time, the distribution processing program 114 controls the network interface 360 to distribute the video frames to various clients via the network 230 (communication medium). The programs cooperate using a function provided by the OS 100 as needed.

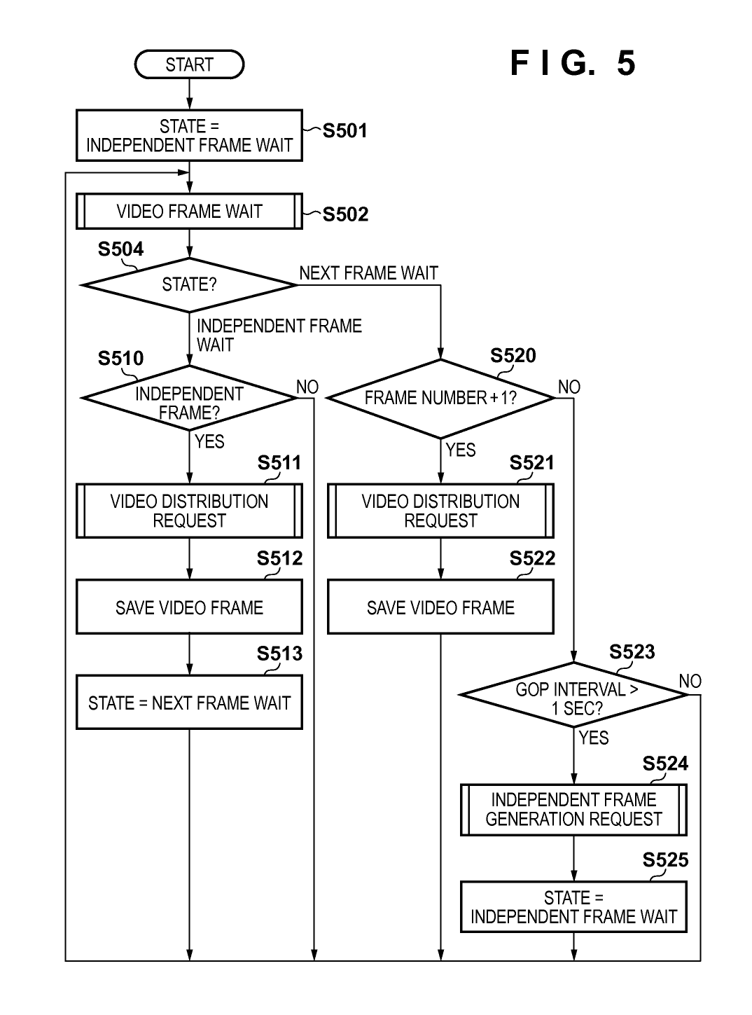

FIGS. 4A and 4B are views exemplifying video frames that have suffered frame loss. FIG. 4A shows an example of video frames when no independent frame is inserted. A video frame 400 represents an independent frame (I frame). A video frame 401 generated next represents a dependent frame (P frame) of the video frame 400. Each of video frames 402 to 407 represents a dependent frame (P frame) of the immediately preceding frame.

A video frame 408 is an independent frame (I frame) and represents that the video frame next to the video frame 407 is coded as an independent frame. A video frame 409 represents a dependent frame (P frame) of the video frame 408. The GOP in FIG. 4A includes the eight video frames 400 to 407. FIG. 4A illustrates that the video frame 402 could not be generated due to some reason such as insufficient processing capability. In this case, the video frames 403 to 407 following the video frame 402 cannot be reproduced without the video frame 402. Hence, a period T410 is a reproduction enable period because there is no video frame loss. A period T411 is a reproduction disable period because of a loss of the video frame 402. When a reproduction disable period occurs, the number of coded frames actually generated during the period until the set time corresponding to the inter-frame predictive coding setting elapses from the start of independent frame generation is smaller than the number of coded frames to be generated during that period. A video frame period T412 from the video frames 408 and 409 is a reproduction enable period because there is no video frame loss.

FIG. 4A has been explained assuming a GOP including eight frames. However, in a state called Long GOP in which the number of frames included in one GOP is large, the period in which reproduction is impossible becomes longer. For example, when the GOP unit is 30 fps, the number of frames is 150 for 5 sec. When the GOP unit is 60 fps, the number of frames is 3,600 for 60 sec. The time period in which reproduction is impossible becomes considerably long depending on the timing of frame loss.

FIG. 4B shows an example of video frames when an independent frame is inserted. Video frame 450 to 459 correspond to the video frames 400 to 409 shown in FIG. 4A. FIG. 4B illustrates a state in which the video frame 452 has been lost, and upon detecting it, an independent frame (I frame) is inserted in the video frame 454. As in FIG. 4A, a period T460 represents a reproduction enable period, a period T461 represents a reproduction disable period, and a period T462 represents a reproduction enable period. As can be seen, the reproduction disable period is shortened from the period T411 to the period T461.

### First Embodiment

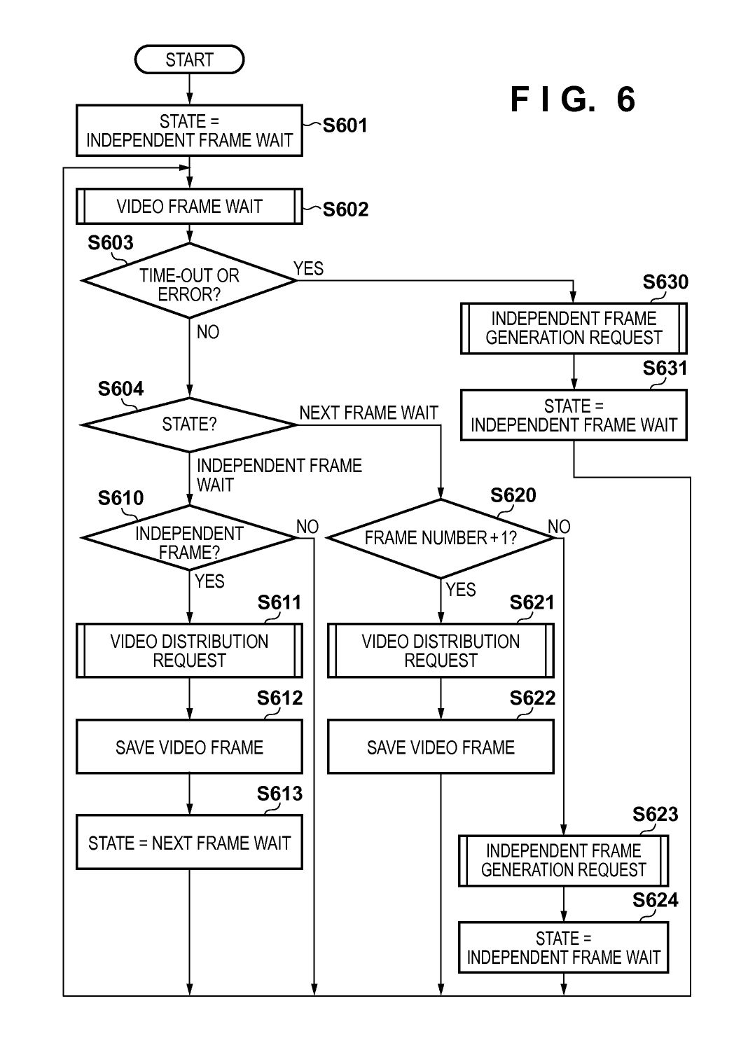

The procedure of processing of a video processing apparatus (camera server 200) according to the first embodiment of the present invention will be described with reference to the flowchart of FIG. 5. The processing procedure shown in FIG. 5 indicates a program that causes a CPU 300 (processor) to execute the procedure shown in FIG. 5. The CPU 300 is a computer and executes the program read out from a secondary storage unit 320 incorporated in the camera server 200.

A video management program 112 is activated by powering on the video processing apparatus (camera server 200) or by a distribution processing program 114 that has received an image acquisition request from a client 220.

In step S501, the activated video management program 112 first sets the internal state to independent frame wait.

In step S502, the video management program 112 waits for video frame generation by a coding processing program 111. A video frame is assumed to include coded video information, a frame number that continuously increases and serves as information used to determine the continuity of the video frame, and information (identification information) used to identify whether the video frame is an independent frame or a dependent frame. The frame number also represents the reproduction order of the video frame.

In step S504, when a video frame is generated by the coding processing program 111, the video management program 112 determines the current internal state. If the internal state is next frame wait, the process advances to step S520. If the internal state is independent frame wait, the process advances to step S510.

In step S510, the video management program 112 determines, based on the identification information included in the video frame, whether the video frame generated by the coding processing program 111 is an independent frame. If the generated video frame is an independent frame (YES in step S510), the video management program 112 requests the distribution processing program 114 to do video distribution (step S511). The video management program 112 saves the generated video frame (video information, frame number, and identification information used to identify whether the video frame is an independent frame or a dependent frame) in a primary storage unit 310 (step S512). The video management program 112 changes the internal state from independent frame wait to next frame wait (dependent frame wait) (step S513), and returns the process to the next video frame wait processing (step S502).

On the other hand, upon determining in step S510 that the video frame is not an independent frame (NO in step S510), the process returns to the next video frame wait processing (step S502) without performing anything.

Upon determining in step S504 that the internal state is next frame wait, the video management program 112 advances the process to step S520. The video management program 112 determines whether the frame number of the generated video frame is the frame number (N+1) representing the video frame next to the saved frame number (N: natural number) by comparing them (step S520). If the frame number of the generated video frame is the frame number representing the next video frame (YES in step S520), the video management program 112 requests the distribution processing program 114 to do video distribution (step S521). The video management program 112 saves the generated video frame (video information, frame number, and identification information used to identify whether the video frame is an independent frame or a dependent frame) in the primary storage unit 310 (step S522).

In the frame number continuity determination processing (step S520), if the frame number of the newly generated video frame is discontinuous to the frame number of the already saved video frame, the process advances to step S523. Upon detecting the discontinuity of the video frame, the video management program 112 can notify the user of it and prompt him/her to change the inter-frame predictive coding setting in the coding processing program 111.

In step S523, the video management program 112 determines whether the interval (independent frame interval: GOP interval) to periodically perform intra-frame coding, which is set in the coding processing program 111, is equal to or longer than a predetermined threshold time (for example, 1 sec).

The interval to periodically perform intra-frame coding is set by the above-described inter-frame predictive coding setting. This set time represents the upper limit of the time from the start of coding processing of a first frame using the intra-frame coding method to the start of coding processing of a second frame using the intra-frame coding method by the coding processing program 111.

If the independent frame interval (GOP interval) is equal to or longer than the threshold time (1 sec) (YES in step S523), the video management program 112 requests the coding processing program 111 to generate an independent frame (step S524). The coding processing program 111 generates an independent frame as the video frame generated next in response to the request from the video management program 112. In step S525, the video management program 112 changes the internal state from next frame wait to independent frame wait.

On the other hand, upon determining in step S523 that the independent frame interval (GOP interval) is shorter than the threshold time (1 sec) (NO in step S523), the process returns to the video frame wait processing (step S502) without performing anything. That is, if the independent frame interval (GOP interval) is set to be shorter than the threshold time, the next independent frame is generated after the elapse of the GOP interval from the preceding independent frame generation even when the frames are discontinuous. On the other hand, if the GOP interval is set to be equal to or longer than the threshold time, the next independent frame is generated before the elapse of the GOP interval from the preceding independent frame generation. In this embodiment, the threshold time in step S523 is set to 1 sec as an example. However, the present invention is not limited to this, and an arbitrary time can be set as the threshold time. The independent frame interval (GOP interval) is generally 0.5 sec to several ten sec.

When the independent frame interval (GOP interval) always takes a value equal to or more than the threshold time, the processing in step S524 may directly be executed without performing the determination processing in step S523. In this embodiment, the video management program 112 determines the independent frame interval (GOP interval). However, the coding processing program 111 may perform the determination upon receiving the independent frame insertion request.

According to this embodiment, the discontinuity of frame numbers included in video frames is detected, and an independent frame is inserted. This allows to shorten the period in which reproduction is impossible.

### Second Embodiment

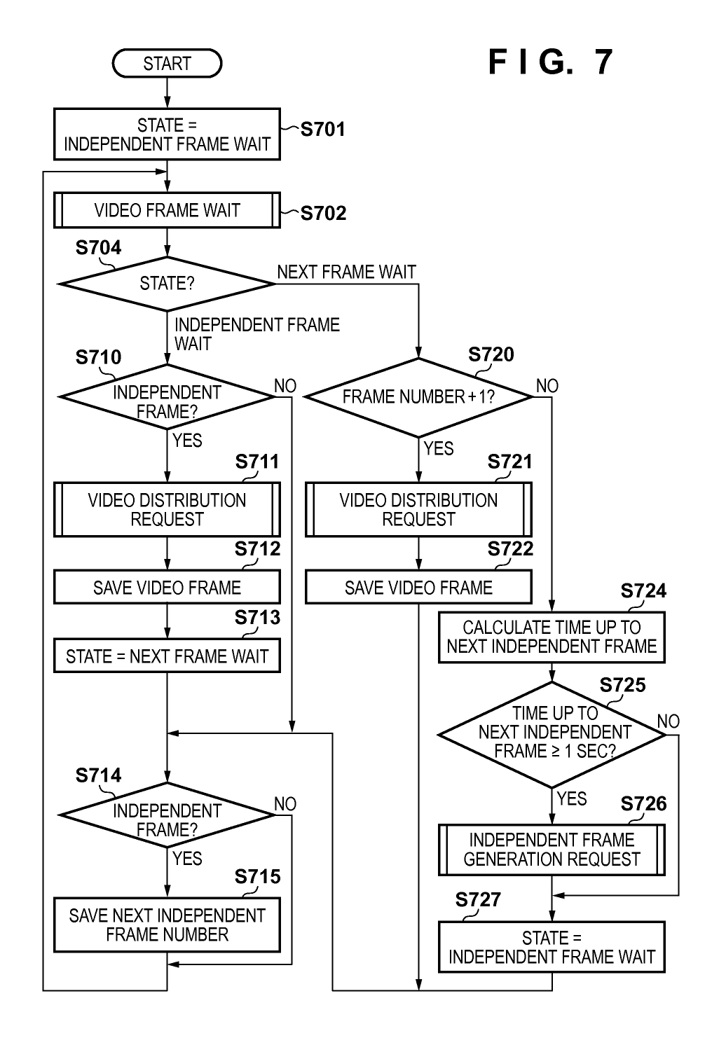

The procedure of processing of a video processing apparatus (camera server 200) according to the second embodiment of the present invention will be described with reference to the flowchart of FIG. 6. The processing procedure shown in FIG. 6 indicates a program that causes a CPU 300 (processor) to execute the procedure shown in FIG. 6. The CPU 300 is a computer and executes the program read out from a secondary storage unit 320 incorporated in the camera server 200.

A video management program 112 is activated by powering on the video processing apparatus (camera server 200) or by a distribution processing program 114 that has received an image acquisition request from a client 220.

The activated video management program 112 first sets the internal state to independent frame wait (step S601).

The video management program 112 designates a time-out time (processing time) used to determine that video frame generation processing has not been performed in time, and waits for video frame generation by a coding processing program 111 (step S602). The video management program 112 determines whether the processing of the coding processing program is completed within the designated time-out time (processing time). If the processing of the coding processing program is not completed, the video management program 112 determines that the frames are discontinuous. A video frame includes coded video information, a frame number that continuously increases and serves as information used to determine the continuity of the video frame, and information (identification information) used to identify whether the video frame is an independent frame or a dependent frame.

In step S603, the video management program 112 determines whether time-out has occurred in the processing of step S602 described above. Alternatively, the video management program 112 determines in step S602 whether an error notification is received from the coding processing program 111. If time-out or error notification has occurred (YES in step S603), the video management program 112 requests the coding processing program 111 to generate an independent frame (step S630). The coding processing program 111 generates an independent frame as the video frame generated next in response to the request from the video management program 112.

The time-out occurs when, for example, the generation interval of a plurality of continuous frames which are generated during the time from independent frame generation to the elapse of the set time of the interval to perform intra-frame coding is equal to or longer than a predetermined processing time.

In step S631, the video management program 112 sets the internal state to independent frame wait, and returns the process to the next video frame wait processing (step S602).

On the other hand, upon determining in step S603 that neither time-out nor error notification has occurred, and a video frame is generated (NO in step S603), the video management program 112 determines the current internal state (step S604). If the internal state is next frame wait, the process advances to step S620. If the internal state is independent frame wait, the process advances to step S610.

In step S610, the video management program 112 determines, based on the identification information included in the video frame, whether the video frame generated by the coding processing program 111 is an independent frame. If the generated video frame is an independent frame (YES in step S610), the video management program 112 requests the distribution processing program 114 to do video distribution (step S611). The video management program 112 saves the generated video frame (video information, frame number, and identification information used to identify whether the video frame is an independent frame or a dependent frame) in a primary storage unit 310 (step S612). The video management program 112 changes the internal state from independent frame wait to next frame wait (step S613), and returns the process to the video frame wait processing (step S602).

On the other hand, upon determining in step S610 that the video frame is not an independent frame (NO in step S610), the process returns to the video frame wait processing (step S602) without performing anything.

Upon determining in step S604 that the internal state is next frame wait, the video management program 112 advances the process to step S620. The video management program 112 determines whether the frame number of the generated video frame is the frame number (N+1) representing the video frame next to the already saved frame number (N: natural number) (step S620). If the frame number of the generated video frame is the frame number representing the next video frame (YES in step S620), the video management program 112 requests the distribution processing program 114 to do video distribution (step S621). The video management program 112 saves the generated video frame (video information, frame number, and identification information used to identify whether the video frame is an independent frame or a dependent frame) in the primary storage unit 310 (step S622).

In the frame number continuity determination processing (step S620), if the frame number of the newly generated video frame is discontinuous to the frame number of the already saved video frame, the process advances to step S623. Upon detecting the discontinuity of the video frame, the video management program 112 can notify the user of it and prompt him/her to change the inter-frame predictive coding setting in the coding processing program 111.

In step S623, the video management program 112 requests the coding processing program 111 to generate an independent frame. The coding processing program 111 generates an independent frame as the video frame generated next in response to the request from the video management program 112. In step S624, the video management program 112 sets the internal state to independent frame wait, and returns the process to the video frame wait processing (step S602).

In this embodiment, the independent frame interval check processing (step S523) described in the first embodiment is omitted. However, this check processing of step S523 may be added before step S623 and before step S630.

That is, when it is determined in step S603 that a time-out error has occurred, and the set time of the interval to perform intra-frame coding is longer than the predetermined time, the independent frame generation request in step S630 is performed. On the other hand, when it is determined that a time-out error has occurred, but the set time of the interval to perform intra-frame coding is equal to or shorter than the predetermined time, the process returns to the video frame wait processing in step S602 without performing the independent frame generation request.

In addition, when it is determined in step S620 that the frame numbers are discontinuous, and the set time of the interval to perform intra-frame coding is longer than the predetermined time, the independent frame generation request in step S623 is performed. On the other hand, when it is determined that the frame numbers are discontinuous, but the set time of the interval to perform intra-frame coding is equal to or shorter than the predetermined time, the process returns to the video frame wait processing in step S602 without performing the independent frame generation request.

According to this embodiment, when no video frame is generated for a predetermined time, or an error in the coding processing is detected, the discontinuity of video frames is detected, and an independent frame is inserted. This allows to shorten the period in which reproduction is impossible.

### Third Embodiment

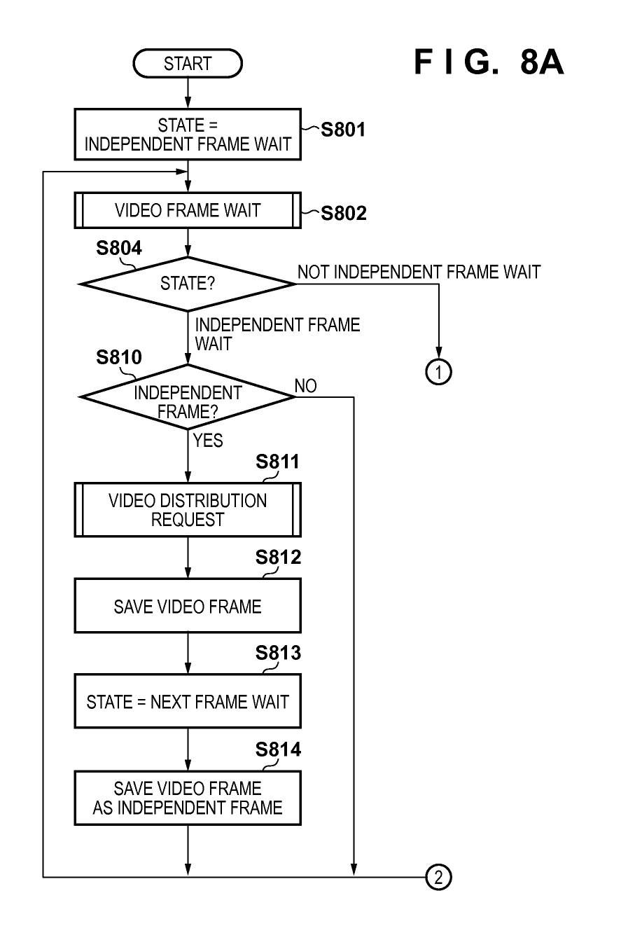

The procedure of processing of a video processing apparatus (camera server 200) according to the third embodiment of the present invention will be described with reference to the flowchart of FIG. 7. The processing procedure shown in FIG. 7 indicates a program that causes a CPU 300 (processor) to execute the procedure shown in FIG. 7. The CPU 300 is a computer and executes the program read out from a secondary storage unit 320 incorporated in the camera server 200.

A video management program 112 is activated by powering on the video processing apparatus (camera server 200) or by a distribution processing program 114 that has received an image acquisition request from a client 220.

The activated video management program 112 first sets the internal state to independent frame wait (step S701).

The video management program 112 waits for video frame generation by a coding processing program 111 (step S702). A video frame includes coded video information, a frame number that continuously increases and serves as information used to determine the continuity of the video frame, and information (identification information) used to identify whether the video frame is an independent frame or a dependent frame.

When a video frame is generated, the video management program 112 determines the current internal state (step S704). If the internal state is next frame wait, the process advances to step S720. If the internal state is independent frame wait, the process advances to step S710.

In step S710, the video management program 112 determines, based on the identification information included in the video frame, whether the video frame generated by the coding processing program 111 is an independent frame. If the generated video frame is an independent frame (YES in step S710), the video management program 112 requests the distribution processing program 114 to do video distribution (step S711). The video management program 112 saves the generated video frame (video information, frame number, and identification information used to identify whether the video frame is an independent frame or a dependent frame) in a primary storage unit 310 (step S712). The video management program 112 changes the internal state from independent frame wait to next frame wait (step S713).

On the other hand, upon determining in step S710 that the video frame is not an independent frame (NO in step S710), the process advances to step S714 without performing anything.

The video management program 112 determines whether the generated video frame is an independent frame (step S714). If the video frame is an independent frame, the number of the next independent frame is saved based on the independent frame interval (GOP interval) (step S715). The information saved in step S715 is the frame number of the next independent frame. However, the information is not limited to the frame number, and any other information such as time information may be saved as long as the interval to the next independent frame can be known from the information.

Upon determining in step S714 that the video frame is not an independent frame, the process returns to the next video frame wait processing (step S702) without performing anything.

Upon determining in step S704 that the internal state is next frame wait, the video management program 112 advances the process to step S720. The video management program 112 determines whether the frame number of the generated video frame is the frame number (N+1) representing the video frame next to the already saved frame number (N: natural number) (step S720). If the frame number of the generated video frame is the frame number representing the next video frame (YES in step S720), the video management program 112 requests the distribution processing program 114 to do video distribution (step S721). The video management program 112 saves the generated video frame (video information, frame number, and identification information used to identify whether the video frame is an independent frame or a dependent frame) in the primary storage unit 310 (step S722).

In the frame number continuity determination processing (step S720), if the frame number of the newly generated video frame is discontinuous to the frame number of the already saved video frame, the process advances to step S724. Upon detecting the discontinuity of the video frame, the video management program 112 can notify the user of it and prompt him/her to change the inter-frame predictive coding setting in the coding processing program 111.

In step S724, the generation time until the next independent frame is generated is calculated from the frame number of the next independent frame saved in step S715 described above and the frame number of the generated video frame (step S724). The video management program 112 determines whether the calculated generation time is equal to or longer than a threshold time (for example, 1 sec) (step S725). If the calculated generation time is equal to or longer than the threshold time (1 sec), the video management program 112 advances the process to step S726. In this embodiment, the threshold time in step S725 is set to 1 sec as an example. However, the present invention is not limited to this, and an arbitrary time can be set as the threshold time.

In step S726, the video management program 112 requests the coding processing program 111 to generate an independent frame. The coding processing program 111 generates an independent frame in response to the request from the video management program 112. In step S727, the video management program 112 sets the internal state to independent frame wait, and advances the process to step S714.

On the other hand, upon determining in step S725 that the generation time is shorter than the threshold time (1 sec) (NO in step S725), the internal state is set to independent frame wait (step S727), and the process advances to step S714 to repeat the same processing. That is, if the generation time up to the next independent frame is shorter than the threshold time, the next independent frame is generated after the elapse of a predetermined time (GOP interval) from the preceding independent frame generation even when the frames are discontinuous. On the other hand, if the generation time up to the next independent frame is equal to or longer than the threshold time, the next independent frame is generated before the elapse of the predetermined time (GOP interval) from the preceding independent frame generation.

In this embodiment, the independent frame interval check processing (step S523) described in the first embodiment is omitted. However, this check processing of step S523 may be added before step S726.

That is, when it is determined in step S725 that the interval up to the next independent frame is equal to or longer than a predetermined time, and the set time of the interval to perform intra-frame coding is longer than the predetermined time, the independent frame generation request in step S726 is performed. On the other hand, when it is determined that the interval up to the next independent frame is equal to or longer than the predetermined time, but the set time of the interval to perform intra-frame coding is equal to or shorter than the predetermined time, the process returns to the video frame wait processing in step S702 without performing the independent frame generation request.

In other words, in a first case to be described below and also in a second case to be described below, coding using intra-frame coding is decided for a frame generated after the discontinuity has occurred. The first case is a case in which the frame numbers of a plurality of frames generated continuously until a time shorter than the set time of the interval to perform inter-frame coding by a predetermined time has elapsed from independent frame generation are discontinuous. The second case is a case in which the set time is longer than the predetermined time.

On the other hand, in the above-described second case and also in a third case to be described below, coding using the inter-frame coding method is decided for a frame generated after the discontinuity has occurred. The third case is a case in which the frame numbers of a plurality of frames generated continuously after a time shorter than the set time by a predetermined time has elapsed from independent frame generation are discontinuous.

That is, even when the frame numbers of a plurality of frames generated continuously during a predetermined period based on the point of time at which the next independent frame is generated are discontinuous, a frame generated during the predetermined period is coded using the inter-frame coding method.

Even if the video frames are discontinuous, an independent frame is inserted only when the time up to the next independent frame is equal to or longer than a predetermined time. This allows to shorten the period in which reproduction is impossible and generate video frames without independent frame continuation.

### Fourth Embodiment

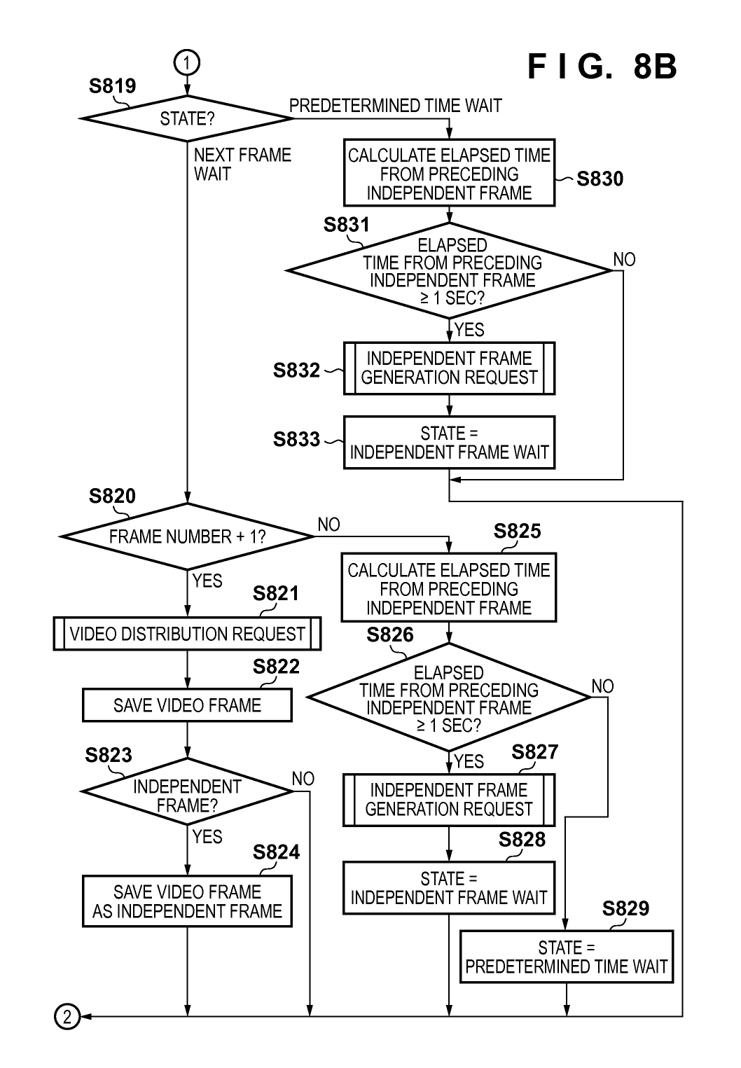

The procedure of processing of a video processing apparatus (camera server 200) according to the fourth embodiment of the present invention will be described with reference to the flowcharts of FIGS. 8A and 8B. The processing procedure shown in FIGS. 8A and 8B indicates a program that causes a CPU 300 (processor) to execute the procedure shown in FIGS. 8A and 8B. The CPU 300 is a computer and executes the program read out from a secondary storage unit 320 incorporated in the camera server 200.

A video management program 112 is activated by powering on the video processing apparatus (camera server 200) or by a distribution processing program 114 that has received an image acquisition request from a client 220.

The activated video management program 112 first sets the internal state to independent frame wait (step S801).

The video management program 112 waits for video frame generation by a coding processing program 111 (step S802). A video frame includes coded video information, a frame number that continuously increases and serves as information used to determine the continuity of the video frame, and information (identification information) used to identify whether the video frame is an independent frame or a dependent frame.

When a video frame is generated, the video management program 112 determines the current internal state (step S804). If the internal state is independent frame wait, the process advances to step S810.

In step S810, the video management program 112 determines, based on the identification information included in the video frame, whether the video frame generated by the coding processing program 111 is an independent frame.

If the generated video frame is an independent frame (YES in step S810), the video management program 112 requests the distribution processing program 114 to do video distribution (step S811). The video management program 112 saves the generated video frame (video information, frame number, and identification information used to identify whether the video frame is an independent frame or a dependent frame) in a primary storage unit 310 (step S812). The video management program 112 changes the internal state from independent frame wait to next frame wait (step S813), and saves the saved video frame (frame number) as an independent frame (independent frame number) (step S814). The process returns to the next video frame wait processing (step S802).

On the other hand, upon determining in step S810 that the video frame is not an independent frame (NO in step S810), the process returns to the next video frame wait processing (step S802) without performing anything.

Upon determining in step S804 that the internal state is not independent frame wait, the process advances to step S819. In step S819, the video management program 112 determines whether the current internal state is next frame wait or predetermined time wait. If the current internal state is next frame wait, the process advances to step S820.

The video management program 112 determines whether the frame number of the generated video frame is the frame number (N+1) representing the video frame next to the already saved frame number (N: natural number) (step S820). If the frame number of the generated video frame is the frame number representing the next video frame (YES in step S820), the video management program 112 requests the distribution processing program 114 to do video distribution (step S821). The video management program 112 saves the generated video frame (video information, frame number, and identification information used to identify whether the video frame is an independent frame or a dependent frame) in the primary storage unit 310 (step S822).

The video management program 112 determines whether the generated video frame is an independent frame (step S823). If the video frame is an independent frame (YES in step S823), the video management program 112 saves the saved video frame (frame number) as an independent frame (independent frame number) (step S824). Upon determining in step S823 that the video frame is not an independent frame (NO in step S823), the process returns to the next video frame wait processing (step S802) without performing anything.

In the frame number continuity determination processing (step S820), if the frame number of the newly generated video frame is discontinuous to the frame number of the already saved video frame, the process advances to step S825. Upon detecting the discontinuity of the video frame, the video management program 112 can notify the user of it and prompt him/her to change the inter-frame predictive coding setting in the coding processing program 111.

The video management program 112 calculates the elapsed time from preceding independent frame generation based on the preceding independent frame number saved in step S814 or S824 described above and the frame number of the generated video frame (step S825). The video management program 112 determines whether the calculated elapsed time is equal to or longer than a threshold time (for example, 1 sec) (step S826). Note that in this embodiment, the independent frame interval (GOP interval) is a time longer than the threshold time (1 sec), for example, 2 sec.

When the elapsed time is equal to or longer than the threshold time, the video management program 112 requests the coding processing program 111 to generate an independent frame (step S827), and changes the internal state from next frame wait to independent frame wait (step S828). The process returns to the next video frame wait processing (step S802).

Upon determining in step S826 that the elapsed time is shorter than the threshold time (for example, 1 sec), the video management program 112 changes the internal state from next frame wait to predetermined time wait (step S829). The video management program 112 returns the process to the next video frame wait processing (step S802).

On the other hand, upon determining in step S819 that the current internal state is predetermined time wait, the process advances to step S830. The video management program 112 calculates the elapsed time from preceding independent frame generation based on the preceding independent frame number saved in step S814 or S824 described above and the frame number of the generated video frame (step S830).

The video management program 112 determines whether the calculated elapsed time is equal to or longer than the threshold time (for example, 1 sec) (step S831).

When the elapsed time is equal to or longer than the threshold time, the video management program 112 requests the coding processing program 111 to generate an independent frame (step S832), and changes the internal state from next frame wait to independent frame wait (step S833). The process returns to the next video frame wait processing (step S802). That is, the video management program 112 causes the coding processing program 111 to generate an independent frame after the elapse of the predetermined time from the preceding independent frame generation.

Upon determining in step S831 that the elapsed time is shorter than the threshold time (for example, 1 sec) (NO in step S831), the video management program 112 returns the process to the next video frame wait processing (step S802).

In this embodiment, the threshold time in steps S826 and S831 is set to 1 sec as an example. However, the present invention is not limited to this, and an arbitrary time can be set as the threshold time.

In this embodiment, the independent frame interval check processing (step S523) described in the first embodiment is omitted. However, this check processing of step S523 may be added before step S827 and before step S832.

That is, when it is determined in step S827 that the interval for the preceding independent frame is equal to or longer than a predetermined time, and the set time of the interval to perform intra-frame coding is longer than the predetermined time, the independent frame generation request in step S827 is performed. On the other hand, when it is determined that the interval from the preceding independent frame is equal to or longer than the predetermined time, but the set time of the interval to perform intra-frame coding is equal to or shorter than the predetermined time, the process returns to the video frame wait processing in step S802 without performing the independent frame generation request.

In other words, in a fourth case to be described below and also in a fifth case to be described below, coding using intra-frame coding is decided for a frame generated after the discontinuity has occurred. The fourth case is a case in which the frame numbers of a plurality of frames generated continuously until a set time has elapsed from the elapse of the predetermined time from independent frame generation are discontinuous. The fifth case is a case in which the set time is longer than the predetermined time.

On the other hand, in the above-described fifth case and also in a sixth case to be described below, coding using the inter-frame coding method is decided for a frame generated until the predetermined time elapses from independent frame generation. The sixth case is a case in which the frame numbers of a plurality of frames generated continuously until the predetermined time elapses from independent frame generation are discontinuous.

That is, even when the frame numbers of a plurality of frames generated continuously during a predetermined period based on the point of time at which the next independent frame is generated are discontinuous, a frame generated during the predetermined period is coded using the inter-frame coding method.

Even if the frame numbers included in the video frames are discontinuous, an independent frame is inserted only when the elapsed time from immediately preceding independent frame generation is equal to or longer than a predetermined time. If the elapsed time is shorter than the predetermined time, an independent frame is inserted after the elapse of the predetermined time. Controlling the timing of generating an independent frame in this way allows to shorten the period in which reproduction is impossible and generate video frames without independent frame continuation.

### Other Embodiments

In the first to fourth embodiments, a case has been described in which the CPU 300 reads out the program stored in the secondary storage unit 320 and executes it to control the operation of each component of the camera server 200. However, the present invention is not limited to this. At least some of the processes shown in FIGS. 5 to 8 may be executed by hardware.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-014585, filed Jan. 26, 2012, which is hereby incorporated by reference herein in its entirety.

What is claimed is:

1. A data transmission apparatus for transmitting coded moving image data to a reception apparatus via a network, comprising:
a coding unit configured to code the moving image data for each frame of the moving image data using an intra-frame coding method that needs no information of other frames upon decoding and an inter-frame coding method that needs the information of other frames upon decoding;
an acquisition unit configured to acquire a set time that sets an upper limit of a time from a start of coding processing of a first frame using the intra-frame coding method by said coding unit to a start of coding processing of a second frame using the intra-frame coding method by said coding unit; and
a decision unit configured to decide, based on at least a length of the set time, whether to code, using the intra-frame coding method, a third frame that undergoes coding processing during a time from the start of the coding processing of the first frame to an elapse of the set time.

2. The apparatus according to claim 1, further comprising a generation unit configured to generate a plurality of frames from the moving image data,
wherein if the number of coded frames generated by said generation unit during the time from the start of the coding processing of the first frame to the elapse of the set time is smaller than the number of coded frames that should be generated during the time from the start of the coding processing of the first frame to the elapse of the set time, and the length of the set time is longer than a predetermined time, said decision unit decides to code the third frame using the intra-frame coding method.

3. The apparatus according to claim 1, further comprising a generation unit configured to generate a plurality of frames from the moving image data,
wherein if a generation interval of a plurality of continuous frames to be generated during a time from generation of the first frame to an elapse of the set time is not less than a predetermined processing time, and the length of the set time is longer than a predetermined time, said decision unit decides to code, using the intra-frame coding method, the third frame generated after the generation interval of the plurality of frames has become not less than the processing time.

4. The apparatus according to claim 1, further comprising:
a generation unit configured to generate a plurality of frames from the moving image data; and
an identification unit configured to identify a frame number representing a reproduction order of each of the plurality of frames generated by said generation unit,
wherein if frame numbers of the plurality of frames generated continuously by said generation unit during a time from generation of the first frame to an elapse of the set time are discontinuous, and the length of the set time is longer than a predetermined time, said decision unit decides to code, using the intra-frame coding method, the third frame generated after the discontinuity has occurred.

5. The apparatus according to claim 1, further comprising:
a generation unit configured to generate a plurality of frames from the moving image data; and
an identification unit configured to identify a frame number representing a generation order of each of the plurality of frames generated by said generation unit,
wherein if frame numbers of the plurality of frames generated continuously by said generation unit during a predetermined period based on a point of time when a frame coded by intra-frame coding is generated are discontinuous, and the length of the set time is longer than a predetermined time, said decision unit decides to code, using the inter-frame coding method, the frame generated during the predetermined period.

6. The apparatus according to claim 1, further comprising:
a generation unit configured to generate a plurality of frames from the moving image data; and
an identification unit configured to identify a frame number representing a generation order of each of the plurality of frames generated by said generation unit,
wherein if frame numbers of the plurality of frames generated continuously by said generation unit during a time from generation of the first frame to an elapse of a time shorter than the set time by a first predetermined time are discontinuous, and the length of the set time is longer than a second predetermined time, said decision unit decides to code, using the intra-frame coding method, the third frame generated after the discontinuity has occurred, and if the frame numbers of the plurality of frames generated continuously by said generation unit after the time shorter than the set time by the first predetermined time has elapsed from generation of the first frame are discontinuous, and the length of the set time is longer than the second predetermined time, said decision unit decides to code, using the inter-frame coding method, the third frame generated after the discontinuity has occurred.

7. The apparatus according to claim 1, further comprising:
a generation unit configured to generate a plurality of frames from the moving image data; and
an identification unit configured to identify a frame number representing a generation order of each of the plurality of frames generated by said generation unit,
wherein if frame numbers of the plurality of frames generated continuously by said generation unit during a time from generation of the first frame to an elapse of the predetermined time are discontinuous, and the length of the set time is longer than the predetermined time, said decision unit decides to code, using the inter-frame coding method, the third frame generated during the time from generation of the first frame to the elapse of the predetermined time, and if the frame numbers of the plurality of frames generated continuously by said generation unit until the set time elapses from the elapse of the predetermined time from generation of the first frame are discontinuous, and the length of the set time is longer than the predetermined time, said decision unit decides to code, using the intra-frame coding method, the third frame generated after the discontinuity has occurred.

8. The apparatus according to claim 1, wherein if the length of the set time is not more than the predetermined time, said decision unit decides to code, using the inter-frame coding method, the frame that undergoes coding processing during a time from the coding processing of the first frame to an elapse of the set time.

9. A data transmission method of transmitting coded moving image data to a reception apparatus via a network, comprising:
a coding step of coding the moving image data for each frame of the moving image data using an intra-frame coding method that needs no information of other frames upon decoding and an inter-frame coding method that needs the information of other frames upon decoding;
an acquisition step of acquiring a set time that sets an upper limit of a time from a start of coding processing of a first frame using the intra-frame coding method in the coding step to a start of coding processing of a second frame using the intra-frame coding method in the coding step; and
a decision step of deciding, based on at least a length of the set time, whether to code, using the intra-frame coding method, a third frame that undergoes coding processing during a time from the start of the coding processing of the first frame to an elapse of the set time.

10. The method according to claim 9, further comprising a generation step of generating a plurality of frames from the moving image data,
wherein if the number of coded frames generated in the generation step during the time from the start of the coding processing of the first frame to the elapse of the set time is smaller than the number of coded frames that should be generated during the time from the start of the coding processing of the first frame to the elapse of the set time, and the length of the set time is longer than a predetermined time, it is decided in the decision step to code the third frame using the intra-frame coding method.

11. The method according to claim 9, further comprising a generation step of generating a plurality of frames from the moving image data,
wherein if a generation interval of a plurality of continuous frames to be generated during a time from generation of the first frame to an elapse of the set time is not less than a predetermined processing time, and the length of the set time is longer than a predetermined time, it is decided in the decision step to code, using the intra-frame coding method, the third frame generated after the generation interval of the plurality of frames has become not less than the processing time.

12. The method according to claim 9, further comprising:
a generation step of generating a plurality of frames from the moving image data; and
an identification step of identifying a frame number representing a reproduction order of each of the plurality of frames generated in the generation step,
wherein if frame numbers of the plurality of frames generated continuously during a time from generation of the first frame to an elapse of the set time are discontinuous, and the length of the set time is longer than a predetermined time, it is decided in the decision step to code, using the intra-frame coding method, the third frame generated after the discontinuity has occurred.

13. The method according to claim 9, further comprising:
a generation step of generating a plurality of frames from the moving image data; and
an identification step of identifying a frame number representing a generation order of each of the plurality of generated frames,
wherein if frame numbers of the plurality of frames generated continuously during a predetermined period based on a point of time when a frame coded by intra-frame coding is generated are discontinuous, and the length of the set time is longer than a predetermined time, it is decided in the decision step to code, using the inter-frame coding method, the frame generated during the predetermined period.

14. The method according to claim 9, wherein if the length of the set time is not more than the predetermined time, it is decided in the decision step to code, using the inter-frame coding method, the frame that undergoes coding processing during a time from the coding processing of the first frame to an elapse of the set time.

15. A non-transitory computer-readable recording medium describing a program that is executed by a computer and causes the computer to execute a transmission method described in claim 9.
